(19) United States
(12) Patent Application Publication
(10) Pub. No.: US 2019/0120311 A1
(43) Pub. Date: Apr. 25, 2019

(54) HIGH EFFICIENCY MULTI-PISTON ACTUATION ASSEMBLY

(71) Applicant: AKEBONO BRAKE INDUSTRY CO., LTD, Tokyo (JP)

(72) Inventor: Waleed Mahmoud Al-Mahshi, Farmington Hills, MI (US)

(21) Appl. No.: 15/789,583

(22) Filed: Oct. 20, 2017

(51) Int. Cl. F16D 65/18; F16H 25/22; B60T 1/06; F16D 55/22; F16H 25/20; F16D 65/00

(52) U.S. Cl. CPC F16D 65/18; F16H 25/22; B60T 1/065; F16D 55/22; F16D 2055/0016; F16H 25/2204; F16H 25/2247; F16D 65/0068; F16H 25/2003

(57) ABSTRACT

A brake system comprising: (a) a brake assembly including; (i) a caliper including: (1) two or more piston bores, (2) a piston located in each of the two or more piston bores, and (3) a spindle extending into each of the two or more piston bores, the spindle being rotationally movable to linearly move each of the pistons within the two or more piston bores to create a braking force; (ii) a motor gear unit in communication with each of the two or more piston bores and connected to each of the spindles extending into each of the two or more piston bores; wherein each of the spindles include threads that receive a plurality of rolling elements and when each of the spindles are rotated the two or more pistons located in each of the two or more piston bores are moved by the respective spindles to create a braking force or releasing a braking force.

### FIELD

The present teachings relate to a brake system that includes two or more pistons per caliper and preferably two pistons per caliper that each include a high efficiency motor gear unit for actuating each of the pistons.

### BACKGROUND

The present teachings are predicated upon providing an improved parking brake for use in an existing disc brake system for use with vehicles. For example, the disc brake system may be used with almost any vehicle (e.g. car, truck, bus, train, airplane, or the like). Alternatively, the disc brake system may be integrated into assemblies used for manufacturing or other equipment that require a brake such as a lathe, winder for paper products or cloth, amusement park rides, wind turbines, or the like. However, the present teachings are most suitable for use with a passenger vehicle (e.g., a car, truck, sports utility vehicle, or the like).

Generally, a braking system includes a rotor, a caliper body, a support bracket, an inboard brake pad, and an outboard brake pad that are on opposing sides of the rotor. The caliper body further includes one or more fingers (with or without a piston), one or more piston bores, and a bridge that connects the one or more fingers to the piston bores or two opposing piston bores together. The piston bores each house a piston. The piston bores each have a bore axis that the pistons move along during a brake apply and a brake retract. The piston bores each include a fluid inlet, a closed wall, a front opening, and a cylindrical side wall that includes a seal groove located near the front opening. Typically, the fluid inlet is located in the closed wall of the piston bore so that when pressure is applied the fluid will flow into the piston bore. During a pressure apply the fluid will push the piston axially towards the front opening and into contact with a brake pad that generally includes a pressure plate and friction material and the friction material will contact the rotor on one side and an opposing brake pad will contact the rotor on an opposing side creating friction to stop rotation of the rotor and any component connected to the brake system. The brake pads may slide on an abutment along an axis of the pistons or the brake pads may include holes that receive pins and the brake pads may slide on pins that extend through the brake system so that a friction force may be created.

However, the braking system may be used in non-braking conditions when the vehicle is parked so that movement of the vehicle is prevented. The parking brake may be a discrete braking system or may use one or more components of a primary braking system. Parking brake systems typically include one or more brake pads and/or brake shoes that may be moved to create a parking force so that the vehicle is restrained during non-movement of a vehicle. These parking brake systems may be actuated by a cable that when moved biases a device that simultaneously actuates the brake pads and/or brake shoes to generate the parking force. More recently, there have been attempts to create a braking system that performs both the service braking and the parking braking.

Examples of braking systems and associated parking brake systems are disclosed in U.S. Pat. Nos. 5,090,518; 5,168,963; 6,450,586; and 6,488,132 and U.S. International Application Publication No. WO2016/015247 and WO2016/064980 all of which are expressly incorporated herein by reference for all purposes. It would be attractive to have a parking brake system that includes multiple actuated pistons that are simple in design and are capable of operating independently. It would be attractive to have a multiple piston caliper that include high efficiency pistons that are movable hydraulically, electrically, pneumatically, or a combination thereof. What is needed is a process of controlling a plurality of discrete braking assemblies to coordinate and work together to create a service brake function, a parking brake function, or both. What is needed is multiple high efficiency brake assemblies that distribute work. It would be attractive to have a multiple caliper system that work independently but cooperate with each other.

### SUMMARY

The present teachings provide: A brake system comprising: (a) a brake assembly including; (i) a caliper including: (1) two or more piston bores, (2) a piston located in each of the two or more piston bores, and (3) a spindle extending into each of the two or more piston bores, the spindle being rotationally movable to linearly move each of the pistons within the two or more piston bores to create a braking force; (ii) a motor gear unit in communication with each of the two or more piston bores and connected to each of the spindles extending into each of the two or more piston bores; wherein each of the spindles include threads that receive a plurality of rolling elements and when each of the spindles are rotated the two or more pistons located in each of the two or more piston bores are moved by the respective spindles to create a braking force or releasing a braking force.

The present teachings include: a method comprising: (a) supplying a signal to both a first motor in a first motor gear unit and a second motor in a second motor gear unit simultaneously; (b) alternating the signal between the first motor in the first motor gear unit and the second motor in the second motor gear unit once contact between a brake pad and a rotor is detected; (c) applying the first motor in the first motor gear unit or the second motor in the second motor gear unit and alternating between the first motor in the first motor gear unit and the second motor in the second motor gear unit until a predetermined braking force is generated; and (d) turning off the first motor and the second motor so that a motor brake is applied to the first motor and a motor brake is applied to the second motor.

The present teachings provide: a parking brake system that includes multiple actuated pistons that are simple in design and are capable of operating independently. The present teachings provide: a multiple piston caliper that include high efficiency pistons that are movable hydraulically, electrically, pneumatically, or a combination thereof. The present teachings provide: a process of controlling a plurality of discrete braking assemblies to coordinate and work together to create a service brake function, a parking brake function, or both. The present teachings provide: multiple high efficiency brake assemblies that distribute work. The present teachings provide: a multiple caliper system that work independently but cooperate with each other.

### BRIEF DESCRIPTION OF THE DRAWINGS

FIG. 1 is a perspective view of a brake system;

FIG. 2 is a top plan view of the brake system of FIG. 1;

FIG. 3 is a cross-sectional view of FIG. 2 along lines III-Ill;

FIG. 4 is a cross-sectional view of FIG. 2 along lines IV-IV;

FIG. 5. is a top view of a piston assembly with a portion of the piston cut away;

FIG. 6 is a cross-sectional view of a piston assembly;

FIG. 7 is a schematic view of a brake system;

FIG. 8 is a perspective view of a fixed caliper with four motor gear units; and

FIG. 9 is a bottom view of the fixed caliper of FIG. 8.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein provide a brake system. The brake system may function to provide a friction force such as a braking force, a parking brake force, a stopping force, or a combination thereof. The brake system may be a combination of all of the braking elements located in a corner of a vehicle. The brake system may be a brake assembly, a rotor, brake pads, a caliper, two or more piston, two or more motor gear units, or a combination thereof. Preferably, the brake system is a twin piston brake assembly and rotor. The brake system may create a braking force, which is a force that stops rotation of a rotor, stops movement of a vehicle, or both. The brake system may create a parking force, which is a force that prevents rotation of a rotor, movement of the vehicle, or both when the vehicle is in a stopped position or in an emergency situation. The brake system may be a pneumatic brake system, an electrical brake system, a hydraulic brake system, or a combination thereof. Preferably, the brake system is a combination hydraulic system and electric system. More preferably, the brake system is hydraulic in one phase and electric in a different phase. The electric brake system may use one or more electric motors to actuate the brake pads. For example, the hydraulic brake system may actuate the brake pads during a standard braking operation and the electric brake system may actuate the brakes upon parking and/or maintaining the brake system in a stopped configuration. The brake system may be an opposing brake system (i.e., a fixed caliper brake system) or a floating brake system (i.e., a floating caliper). The brake system may move the same piston and the same brake pads in the electric phase as are moved in the hydraulic phase. The brake system may include one or more brake pads, two or more pistons, one or more rotors, a brake assembly, or a combination thereof. Preferably, each brake system includes two piston and two motor gear units each with an electric motor that electrically actuates the piston. Each brake system may include multiple pistons or two opposed pistons that are each actuated by a single motor. More preferably, a twin piston brake assembly is located within a rim in two or more corners of a vehicle (e.g., the rear tires).

The rim may function to support a tire, a rotor, the brake system, a brake assembly, or a combination thereof. The rim may surround all or a portion of one or more brake assemblies. Preferably, a brake system with two or more pistons is located within a rim of a corner module (e.g., a quadrant of a vehicle where a tire meets the ground). The rim may house the rim and a plurality of brake systems.

The one or more brake assemblies function to move one or more brake pads into contact with a rotor to create a parking brake apply, a stopping brake apply, release a brake apply, or a combination thereof. The one or more brake assemblies may include a caliper, brake pads, support bracket, two or more pistons, two or more motor gear units, or a combination thereof. Preferably, each brake assembly includes two or more pistons and two or more motor gear units. More preferably, each brake assembly or piston of a brake assembly works in conjunction with another brake assembly or another piston to stop motion of a vehicle, prevent motion of a vehicle, or both. The one or more brake assemblies may individually each create a braking force. Each brake assembly may individually stop a vehicle or prevent motion of a vehicle. Preferably, the brake system includes one brake assembly with a plurality of pistons. Each of the brake assemblies may be in communication with a rotor. Each brake assembly includes two or more brake pads that are axially moved along an axis of the piston bore to create a braking force.

The one or more brake pads may function to create a friction force (e.g., a stopping force, a parking force, a braking force, or a combination thereof) when moved into contact with another member (e.g., a rotor, drum, or the like). The one or more brake pads may include one or more portions that assist in creating a friction force. The one or more brake pads may include a pressure plate and friction material. The friction material may be free of copper, steel, steel fibers, ceramic fibers, or a combination thereof. The one or more brake pads may be opposing brake pads. The one or more brake pads may contact opposing sides of the member (i.e., body assembly) during a friction force (i.e., one or more brake pads on each side of a rotor). For example, the brake pads may contact opposing pistons, or two or more adjacent pistons and one or more opposing fingers. All or a portion of the brake pads may be moved to create a parking brake force. For example, if there are multiple pistons on each side of the body assembly, rotor, or both one or more pistons on each side of the rotor may be actuated pushing a portion of the brake pad into contact with the rotor so that a parking brake force is created. The one or more brake pads may be moved into contact with a rotor by a piston, fingers, or a combination of both.

The rotor may function to assist in creating a friction force. The rotor may extend between two or more opposing brake pads so that one or more brake pads contact each side of the rotor to create a friction force. The rotor rotates around an axis of rotation. The rotor may be generally circular and may extend through a body assembly, be connected to a body assembly, be partially surrounded by a body assembly, or a combination thereof. Preferably, the rotor extends through the one or more brake assemblies (e.g., a caliper) so that an inboard brake pad extends along an inboard face of the rotor and an outboard brake pad extends along an outboard face of the rotor. As the rotor is slowed by the one or more brake assemblies and the rotor stops a corresponding tire of a vehicle. The rotor may be made of steel, iron, a ferrous material, or a combination thereof. The brake pads may be moved into contact with the rotor by one or more pistons in a caliper moving into contact with the respective brake pads or a piston contacting one brake pad and fingers of a caliper moving into contact with an opposing brake pad.

The caliper (e.g., body assembly) may function to move two or more brake pads into contact with a rotor to create a friction force. The caliper may move during a brake apply or release (i.e., be a floating caliper). The caliper may be fixed so that a body of the caliper does not move to create a friction force (i.e., a fixed caliper). The caliper may be connected to two or more opposing surfaces, pins, or both and may slide along the two or more opposing surfaces, pins, or both so that a friction force is created. The caliper may be connected to a knuckle via one or more guide pins. The caliper may move along the one or more guide pins. The caliper may be static relative to the one or more guide pins. The caliper may be directly connected to a knuckle or support structure. The caliper may include an inboard side and an outboard side that are connected by a bridge extending there between. The inboard side, outboard side, or both may include one or more of the following: one or more pistons, one or more fingers, two or more pistons, or two or more fingers. The inboard side may be located on an inside of a body of a vehicle and be free of exposure to an area around a vehicle and an outboard side may face an area on an outside of a vehicle. The caliper may be movable connected to a support bracket. The caliper may be free of a separate support bracket and may act as its own support bracket.

The support bracket may function to connect a caliper to a vehicle. The support bracket may be grounded and a caliper may move relative to the support bracket. The support bracket may include one or more pins or bolts and the caliper may move along the pins or bolts. The support bracket may be directly connect to the caliper. The support bracket may carry the brake pads. The support bracket may include pins or bolts that carry the brake pads. The support bracket may assist in carrying a motor gear unit (MGU). The support bracket may be free of contact with a motor gear unit. The brake assembly may be free of a support bracket. The support bracket may be connected to the knuckle via one or more bolts. A single support bracket may carry two or more calipers. The support bracket may be connected to the caliper via one or more bolts. The one or more bolts may include a boot. The boot may be a dust boot. The boot may retain lubrication. The boot may move with the caliper, along a pin, or both as the caliper is moved by one or more pistons extending in and out of the one or more piston assemblies.

The one or more piston assemblies (e.g., piston, piston bore, spindle, nut, rolling elements, rotary to linear actuator, or a combination thereof) may function to move one or more brake pads, create a friction force, or both. All or a portion of the one or more piston assemblies may function to move forward and backward along an axis (i.e., axially in and out of the piston bores) so that one or more brake pads create a friction force and are released from creating a friction force. A portion of the one or more piston assemblies may be moved hydraulically, pneumatically, electrically, or a combination thereof to create a brake apply, a parking brake apply, a brake release, or a combination thereof. Preferably, the one or more piston assemblies create a braking force using one method of moving the brake pads and the piston assemblies create a parking force using a different method of moving the brake pads. For example, the braking force may be created by the piston assembly creating a hydraulic force to move the brake pads, and the parking force may be creating by the piston assembly electrically moving the brake pads. The piston assemblies each may include a piston and a piston bore and the piston may extend along an axis of the piston bore.

Each piston bore may function to house one or more pistons, one or more components that move a piston, be all or a portion of a piston assembly, or a combination thereof. Each caliper may include two or more piston bores. Each caliper may include a plurality of piston bores. Preferably, each caliper includes two or more piston bores. Each caliper may include about four or more, about six or more, about eight or more, or even about ten or more piston bores. The piston bores may all be located on one side (e.g., outboard side). The piston bores may be located on opposing sides of the caliper (e.g., inboard side and outboard side). The piston bore may connect a piston assembly to a bridge, a caliper, or both. One or more piston bores may be located on the inboard side, the outboard side, or both of a caliper. Two or more piston bores may be located on the inboard side or the outboard side only of the body assembly. Two or more piston bores may be located on both the inboard side and the outboard side of the body assembly. The piston bore may include a closed side and an open side. The closed side may be walls that are located on the outside of the piston assembly and the open side may be centrally located so that the pistons may be moved from the piston bores towards each other, a brake pad, a rotor, or a combination thereof. The piston bores may be located adjacent, opposed, side by side, or a combination thereof. Each of the piston bores include a piston bore axis. When one or more opposing pistons are used, each of the axes of the piston bores are generally aligned, generally parallel, or both (e.g., ±1°). The one or more piston bores may each include a piston. The one or more components that each piston bore may include are one or more bearings, one or more rolling elements, one or more threaded elements, one or more spindles, one or more nuts, one or more pistons, a fluid, one or more seals, one or more rotary to linear actuators, or a combination thereof.

The one or more pistons may function to move in and out of a piston bore to create a friction force. The one or more pistons may move along an axis, the piston bore axis, or both. The one or more pistons may function to move one or more brake pads. The one or more pistons may assist in sealing the piston bore so that a fluid is trapped within the piston bore, the piston, or both. The one or more pistons may have sufficient strength so that the one or more pistons may be moved by a fluid, moved by air, moved by an electrical device, or a combination thereof to create a friction force. The one or more pistons may assist in sealing the open side of the piston so that a fluid, an actuation device, or both is sealed within the piston bore. The piston may be made of or include metal, aluminum, steel, phenolic, plastic, iron, a cap, or a combination thereof. The actuation device may include one or more components that move the piston. The one or more pistons may include one or more threads, be in direct contact with one or more rolling elements, be directly connected to a spindle via one or more rolling elements, or a combination thereof. The one or more pistons may include an anti-rotation device so that the pistons are free of rotation.

The anti-rotation device may function to prevent the piston from rotating. The anti-rotation may function to permit the rotary to linear actuator to move the piston without the piston rotating. The anti-rotation device may be located between the piston and the piston bore. The anti-rotation device may be part of the piston, the piston bore, or both. The anti-rotation device may prevent rotation during a hydraulic apply, an electric apply, a release, or a combination thereof. The anti-rotation device may extend around an outside of the piston. The anti-rotation device may be an elastomeric piece that extends between the piston and the piston bore to prevent rotation of the piston. The anti-rotation device may be rubber, silicone, metal, plastic, oil resistant, brake fluid resistant, or a combination thereof. Preferably, the anti-rotation device is an O-ring. The anti-rotation device may be a circlip. The anti-rotation device may be a feature formed into an exterior of the piston, an interior of the piston bore, or both. The anti-rotation device may be a feature in a wall (e.g., a flat wall, arcuate wall, flat portion, a projection, a depression, or a combination thereof) so that upon some rotation of the piston the feature in the wall contacts a wall of the piston bore or a piece connected to a wall of the piston bore and further rotation is prevented. The anti-rotation device may be a combination of an elastomeric piece and an exterior wall of the piston. The anti-rotation device may be a combination of a shape in an exterior wall of the piston and a material wrapped around an exterior of the piston. The piston during creation of a friction force may be moved by a fluid, a spindle, ball ramp, rotary to linear actuator, a drive gear, or a combination thereof.

The one or more rotary to linear actuators function to axially move a piston upon rotation. The one or more rotary to linear actuators may be axially static; relative to the piston, the motor, or both, while rotating about an axis. The one or more rotary to linear actuators may expand axially by being rotated. The one or more rotary to linear actuators may include one or more rolling elements and preferably a plurality of rolling elements. The one or more rotary to linear actuators may only rotate during an electric brake apply or release. The one or more rotary to linear actuators may rotate during a hydraulic brake apply or release. The one or more or more rotary to linear actuators may have a rotational piece and a static piece. The one or more rotary to linear actuators may be a spindle and nut, a ball ramp, or both.

A wall of the piston may form one wall or side of a ball ramp. For example, one or more ball bearings may be in direct contact with a wall of the piston. In another example, the ball bearings may be sandwiched between a wall of the piston and a first wall of the ball ramp so that as the wall of the ball ramp rotates the piston is axially moved. The ball ramp may have a first wall and a second wall with a rolling element located between the first wall and the second wall. The first wall, the second wall, or both may be flat. The first wall, the second wall, or both may have a ramped surface so that as the rolling element, the ramped surface, or both are moved the ball ramp axially expands or contracts. The one or more ball ramps may be free of contact with a spindle. The one or more ball ramps may be contacted by a spindle that may rotate the first wall, the second wall, or both. The brake system may be free of ball ramps. The rotary to linear actuators may be a combination of ball ramps, spindles, or both to axially move the one or more pistons during a brake apply, a brake release, a parking brake apply, a parking brake release, or a combination thereof.

The one or more spindles may function to move one or more pistons to create a friction force. The one or more spindles may move along an axis of the spindle, an axis of the piston, an axis of the piston bore, or a combination thereof. The one or more spindles may be any configuration that an electric motor, a hydraulic device, a pneumatic device, a linear actuator, a stepper motor, or a combination thereof may move the spindle along an axis to create a friction force. The one or more spindles may function to contact a rear side of a piston and axially move the piston and an associated brake pad into contact with a rotor, towards an opposing brake pad and/or piston, or both. The one or more spindles may function to be moved in any manner so that the spindles contact a piston and axially move the piston to create a braking force, a parking force, or both. The one or more spindles may include one or more threads that assist in axially moving the spindle. The one or more spindles may include threads that helically wrap around the spindles and axially move the spindles in and out of the piston bore. The threads may be in contact with a nut or a piston and upon rotational movement of the spindle, the nut, the piston, or both may axially move relative to the spindle. The spindle may include one or more gears, one or more geared portions, or both on the elongated portion so that the spindle may be axially moved. The one or more spindles may include one or more threads. The one or more thread may be lead thread (e.g., a lead screw). Preferably, the one or more spindles include threads that receive rolling elements so that the spindles are high efficiency spindles (e.g., require a low force to rotate the spindle relative to a nut or piston (i.e., a force that is less than 50% that of a threaded spindle)). The one or more spindles may be made of any material that is resistant to a fluid and in particular brake fluid. The one or more spindles may be made of plastic, a phenolic resin, a metal (e.g., steel, stainless steel, aluminum, or a combination thereof), a polymer, or a combination thereof. The one or more spindles may be substantially solid. Preferably, the one or more spindles may include one or more apertures and preferably a plurality of apertures for a fluid to pass through the spindle and into contact with a back side of the piston so that the fluid moves the piston to create a friction force. The plurality of apertures may be located within a pushing portion. The one or more spindles may include a pushing portion and an elongated portion.

The pushing portion may function to contact the piston and move the piston to a braking position, to create a friction force. The pushing portion may allow fluid to pass through so that a hydraulic braking force may be created. The pushing portion may function to evenly distribute pressure across a face of a piston so that an even distribution of force is applied on the brake pads. The pushing portion may be generally planar. The pushing portion may be porous, include apertures, include through holes, or a combination thereof. The pushing portion may have a hub and spoke configuration. The pushing portion may have a shape that mirrors the shape of the piston. The pushing portion may be substantially perpendicular to the piston bore axis. The pushing portion may be a nut that is in communication with the elongated portion. The pushing portion and the elongated portion may be one part. Preferably, the nut and elongated portion are two pieces that are axially movable separately from each other. The pushing portion may be the piston itself. For example, the brake assembly may be free of a nut and the elongated portion may directly provide a force to the piston so that the piston is axially moved. The pushing portion may be movably connected or rigidly connected to the elongated portion.

The elongated portion may function to move the pushing portion along an axis to move the piston. The pushing portion (e.g., a nut) and the elongated portion (e.g., spindle) may be two separate pieces. When the elongated portion is discrete from the pushing portion the elongated portion may be the spindle. However, if the pushing portion and elongated portion are one piece then together they comprise the spindle. The elongated portion may be in communication with a component that moves the spindle axially (e.g., a nut or in moving communication with the piston). The elongated portion may be threaded, may include one or more axial driving features, steps, ratchet features, apertures, recesses, grooves, grooves with rolling elements, or a combination thereof. The elongated portion may be rotated relative to the pushing portion. Preferably, the elongated portion and the pushing portion may move as one unit. The one or more spindles may be rotated about an axis and as the one or more spindles rotate the spindle may move along an axis. The one or more spindles remain substantially rotationally static and the one or more components (e.g., nut or gears) rotate about the spindle to axially advance the spindle. Preferably, the spindle may rotationally move and the nut, piston, or both may be rotationally static. The elongated portion may be threaded and may be in communication with a nut. The elongated portion (e.g., spindle) may rotate to axially move the nut, the piston, or both and the elongated portion may remain axially static. The elongated portion may be in direct contact with a piston and be free of a nut. The elongated portion may have threads that are in direct contact with threads of a piston. The elongated portion may include grooves that include rolling elements that are in contact with a nut, a piston, or both. The rolling elements may be balls, cylinders, or both. The rolling elements may be low friction rolling elements when compared to a threaded connection. The rolling elements may rotate as the elongated portion rotates but may assist in axially moving the nut, the piston, or both. When rolling elements are present the spindle may be a high efficiency spindle. When threads are present without rolling elements the spindle may be a low efficiency spindle. The spindle may be rotated by a motor, a motor gear unit, a gear assembly, or a combination thereof. The spindle may be in direct contact with a gear assembly of a motor gear unit and the gear assembly may transfer torque from the motor to the spindle.

The gear assembly functions to rotate the spindle. The gear assembly functions to increase torque from the motor, increase rotational speed from the motor, decrease torque, decrease rotational speed from the motor, or a combination thereof. The gear assembly may assist in rotating the spindle so that the piston is axially moved and a braking force is created. The gear assembly may be a planetary gear system, helical gear, belt, chain, a worm gear, a differential, a multi-stage planetary gear system, spur-gear assembly, or a combination thereof. Preferably, the gear assembly includes one or more planet gears, sun gears, cages, or a combination thereof. The gear assembly may include a series of gears that are connected together to rotate the spindle. The gear assembly may increase the speed, torque, or both of the spindle relative to the rotational speed of the motor. The gear ratio of the motor to the spindle may be about 50:1 or more, about 75:1 or more, about 100:1 or more, about 150:1 or more, about 200:1 or more, about 400:1 or more, or about 600:1 or more. The gear ratio of the motor to the spindle may be about 5000:1 or less; about 2500:1 or less; or about 1000:1 or less. For example, for every 100 revolutions of the motor the spindle will rotate 1 times (i.e., 100:1). The gear assembly may include a driven gear, a driving gear, a sun gear, planetary gears, a ring gear, or a combination thereof. The gear assembly may be in direct contact with a motor, a driving gear of the motor, or both.

The motor may function to provide energy to one or more devices so that friction force is generated. The motor may function to directly and/or indirectly move one or more piston assemblies. The motor may function to actuate the one or more brake pads by a hydraulic force, an electric drive, a pneumatic drive, or a combination thereof. Preferably, the motor rotates one or more spindles during an electric brake apply or an electric brake release so that one or more pistons are axially moved. More preferably, each motor may only move one piston. Each motor may rotate and provide torque to a gear assembly and the gear assembly may increase or decrease the torque and move the spindle so that the spindle axially moves a piston to create a brake apply or brake release. Each motor may rotate at a speed so that a gear assembly is rotated and the gear assembly may increase or decrease rotational speed to the spindle so that the spindle axially moves the piston to create a brake apply or brake release. The motor may include or be connected to one or more motor brakes that prevent back drive of the motor when the motor is turned off.

The one or more motor brakes may function to prevent back drive of a piston when a motor is turned off. Each motor gear unit may include one or more motor brakes. Preferably, each motor gear unit includes a motor brake that is in communication with a shaft of the motor. The motor brake may be located to a rear side of the motor that is opposite the drive side of the motor where the motor provides torque to the rotary to linear actuator. The motor brake may be one or more gears. The motor brake may be one or more worm gears. The motor brake may be or include a pawl, a wrap spring, two plates that contact each other, or a combination thereof. The motor brake may create friction so that an amount of force placed on the brake pads cannot back drive the pistons. The motor brakes prevent rotation of a motor shaft so that the rotary to linear actuator remains axially static while the motor is off, the motor brake is on, or both. The motor, motor brake, gear assembly, or a combination thereof may be located in a single package (e.g., a motor gear unit).

The motor gear unit may function to axially move the piston to create a brake apply, maintain a brake apply, brake release, or a combination thereof. The system may include one or more motor gear units. Preferably, each corner or each brake system includes at least two motor gear units (i.e., one for each brake assembly). Each brake assembly may include one or more motor gear units. Each motor gear unit may be operated independently of any other motor gear units. All of the motor gear units may be connected to a single brake assembly in a brake system. Each motor gear unit may move a single piston. Each motor gear unit may be connected to a piston bore of a caliper. Each motor gear unit may be connected to and extend cantilever from a piston bore. The motor gear units may be connected to a knuckle, a caliper, a support bracket, or a combination thereof. The motor gear units may be connected to a control system, a control unit, or both. The plurality of motor gear units may be controlled by a control system.

The control system may function to coordinate a brake apply or brake release between one or more brake assemblies and preferably two or more brake assemblies. The control system may function to coordinate a brake apply or brake release between two or more motors, motor gear units, or both. The control system may control the brake system (e.g. the brake systems in each of the 4 corners on a vehicle). Each corner may include a control system. Each brake system may be controlled individually. All of the brake systems in the corners may be controlled together. The control system may apply two or more brake assemblies, two or more motor gear units, or both simultaneously. The control system may apply or release two or more brake assemblies or two or more motor gear units, in series. The control system may apply or release two or more brake assemblies or two or more motor gear units, in parallel. The control system may apply one brake assembly and then a second brake assembly or one motor gear unit and then another motor gear unit. The control system may operate one brake assembly and then the second brake assembly. The control system may alternate between two or more brake assemblies or two or more motor gear units. The control system may fully operate one brake assembly or motor gear unit and then fully operate a second brake assembly or motor gear unit. The control system may operate only one brake assembly or motor gear unit per parking brake apply or release and may alternate between the two or more brake assemblies each time a parking brake apply is created or released. For example, if the brake assembly include three pistons on one side of a caliper, a motor gear unit in a center of the three pistons may apply only the center piston. The control system may allow a user to select a level of parking brake applied. For example, if the brake system is on a large truck the control system may allow a user to select a no load condition where only one motor gear unit is applied and then a high load condition (e.g., a trailer is connected, a storage area is filled, or the vehicle is parked on a hill) so that two or more motor gear units are applied. During an electric brake apply, the control unit may determine if a hydraulic assist is needed to complete a brake apply. The control system may monitor current conditions of the brake assemblies to determine if a re-clamp is needed of one or more of the brake assemblies. The control system may determine a temperature of the brake assemblies to determine if a re-clamp is needed. The control system may include one or more control units.

The control units may function to monitor one or more brake assemblies, motor gear units, motors, or a combination thereof for a current condition, control movement of the one or more brake assemblies, current position, control an amount of pressure created by each of the brake assemblies, or a combination thereof. The control units may be connected to one or more sensors. The control units may monitor current, voltage, or both to determine a position of the brake pads, the piston, the spindle, a rotary to linear actuator, or a combination thereof. The control unit may be connected to one or more sensors that monitor the brake assemblies. Preferably, the control unit monitors the brake assemblies by monitoring conditions of the motor, energy supplied to the motor, a duration of time, or a combination thereof. The control unit may monitor position of the brake assembly, piston, brake pads, or a combination thereof during a hydraulic brake apply, an electric brake apply, a brake release, or a combination thereof. The control unit may provide feedback to a control system and the control system may decide which control unit, brake assembly, or both to power first. The control unit may be connected to one or more valves. The control unit may control both the hydraulic application of the brakes and the electric application of the brakes. The control unit may turn on or off the hydraulic system of one or both of the brake assemblies based upon a sensed condition, an input condition, or both. The control unit may control the hydraulic system by one or more valves.

The one or more valves may function to turn on and off hydraulic fluid to one or more of the piston assemblies. The one or more valves may each connect to a brake assembly. The one or more valves may be a ball valve, gate valve, globe valve, butterfly valve, or a combination thereof. The one or more valves may prevent a hydraulic fluid from extending to the one or more brake assemblies so that a hydraulic brake apply is not created. The hydraulic system may be free of valves.

The hydraulic system functions to move the one or more pistons during a service brake apply. The hydraulic system may generate fluid pressure to move or actuate one or more pistons or two or more pistons. The one or more hydraulic systems may move hydraulic fluid to all of the brake assemblies so that all of the brake assemblies are applied simultaneously. The hydraulic system may include one or more hydraulic units that apply hydraulic fluid to the brake assemblies to create a brake apply.

The hydraulic unit functions to increase pressure in the hydraulic system to create a braking force. The hydraulic unit may distribute brake fluid to one or more of the brake assemblies, one or more of the pistons, or both. The hydraulic unit may alternate in applying brake fluid to the brake assemblies. Each brake assembly may include its own hydraulic unit.

The brake system may be controlled via a process and the process may perform any of the steps taught herein in virtually any order. The process may include a step of actuating one piston and then actuating a second piston. All brake pistons may be actuated at the same time. One motor gear unit may be turned off so that less than all of the pistons are actuated. The brake assemblies may be electrically, hydraulically, or both turned on an off. The pistons may re-clamp one at a time. The pistons may all re-clamp at the same time. The brake assemblies may be monitored by one control unit or multiple control units. The brake assemblies may be controlled independently of one another. The brake assemblies of one wheel may be tied to a brake assembly of another wheel. For example, if each wheel includes two motors then the first motors of each wheel may be controlled together and the second motors of each wheel may be controlled together. Thus, if the first motor is turned off on one side the first motor is turned off on a second side (or re-clamped, released, clamped, pressure increased, etc . . . ). A first motor in a first motor gear unit, a second motor in a second motor gear unit, or both may be actuated, may be actuated simultaneously, actuated in series, actuated alternatingly, or a combination thereof. All of the motors may be turned off and a motor brake may be applied to prevent back drive of each of the motors. The motors may be turned back on before a motor brake is released. The motor brake may be released before a motor is turned back on. Each brake actuator may be reclamped by releasing one or all of the motor brakes and turning on the motors to reapply a braking force. The motor brakes may be turned back on and the motors turned off.

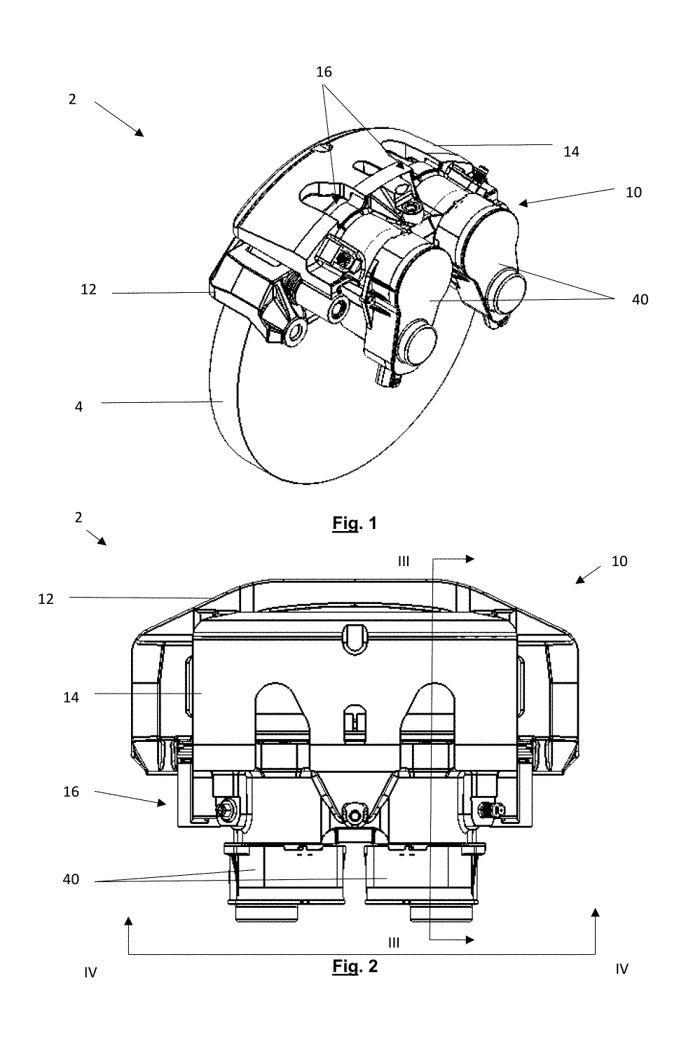

FIG. 1 is a perspective view of a brake system 2. The brake system 2 includes a brake assembly 10 extending over a rotor 4. The brake assembly 10 includes a support bracket 12 and a caliper 14 with a pair of motor gear units 40 connected to the caliper 14.

FIG. 2 is a top view of a brake system 2. The brake system 2 includes a brake assembly 10 including a support bracket 12, caliper 14, and two piston bores 16. Each of the piston bores 16 is connected to a motor gear unit 40.

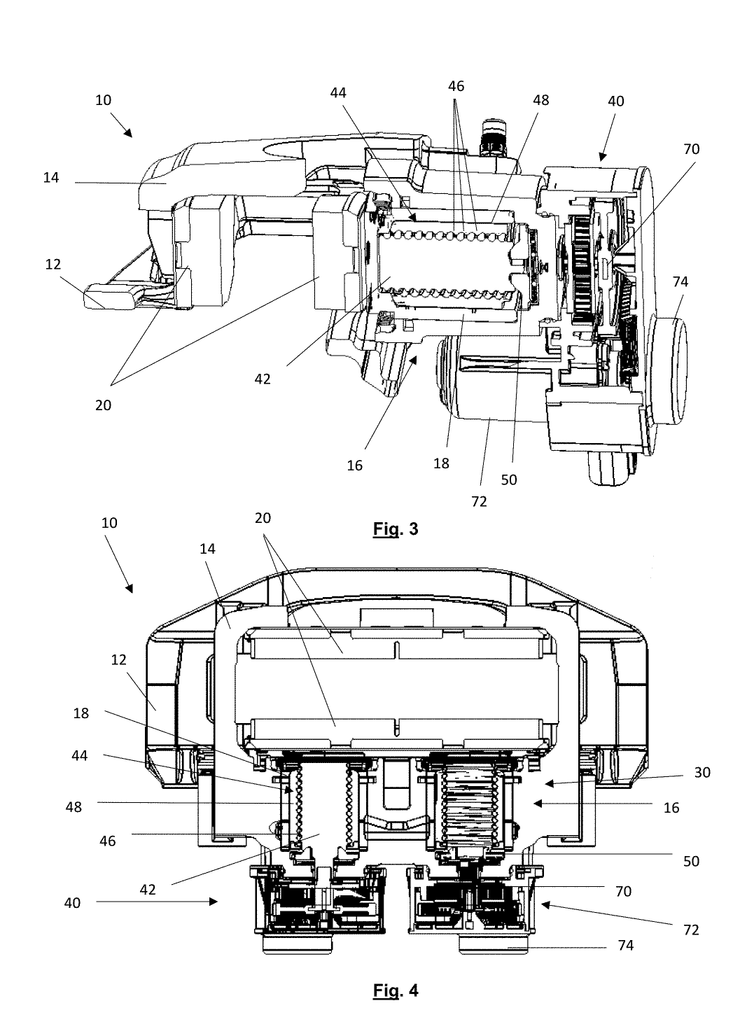

FIG. 3 is a side cross-sectional view of the brake assembly 10 of FIG. 2 cut along lines III-Ill. The brake assembly 10 includes a caliper 14 and a support bracket 12. The caliper 14 has a piston bore 16 that includes a piston 18 and spindle 42 connected to a motor gear unit 40. The motor gear unit 40 includes a motor 72, a motor brake 72, and a gear assembly 70 that rotationally move the spindle 42. The spindle 42 a nut 48 are located within a piston 18 and each of the spindle 42 and nut 48 include threads 44. The spindle 42 is in communication with the nut 48 via rolling elements 46, which efficiently provide an axial force on the spindle so that the spindle is longitudinally moved about its axis. An end of the spindle 42 is supported by a bearing 50 that allows the spindle 42 to rotate about its axis axially moving the nut 48 and piston 18.

FIG. 4 is a top cross-sectional view of the brake assembly 10 of FIG. 2 cut along lines IV-IV. The brake assembly 10 includes a support bracket 12 that supports a caliper 14 and a pair of opposing brake pads 20 that are axially moved by the caliper 14. The caliper 14 includes two piston assemblies 30 each including a piston bore 16 that each include a piston 18 with a nut 48 and spindle 42 located therein. The nut 48 and spindle 42 each include threads 44 holding a plurality of rolling elements 46 so that rotational movement of the spindle 42 axially moves the nut 48. One end of each spindle 42 is supported by a bearing 50. The spindle 42 is connected to a motor gear unit 40 that includes one or more gear assemblies 70 and a motor 72 connected to a motor brake 72.

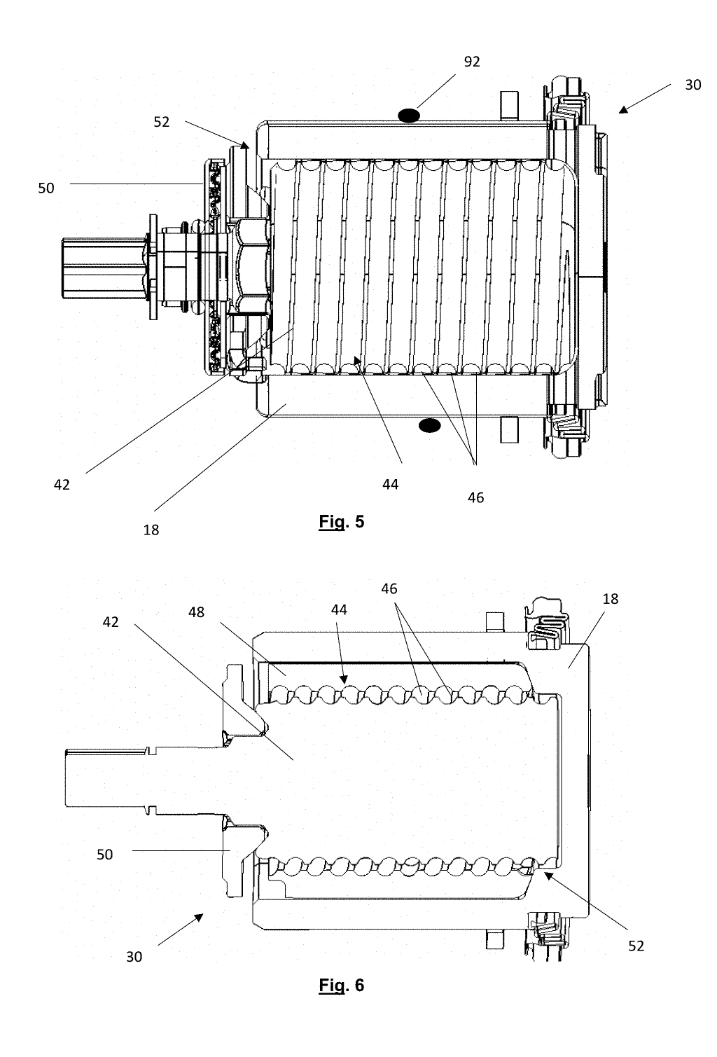

FIG. 5 is a partial cross-sectional view of a piston assembly 30 with a partial cut away of the piston 18. A rotary to linear actuator 52 includes a spindle 42 that includes threads 44 that are in communication by a plurality of rolling elements 46 (i.e., there is no nut present) is visible in the piston 18. As shown the piston 18 is partially cut away so that the spindle 42 is visible. The spindle 42 at one end is connected a bearing 50 that supports and allows for rotation of the spindle 42.

FIG. 6 is a cross-sectional view of a piston assembly 30 with a partial cut away of the piston 18. The rotary to linear actuator 42 includes a spindle 42 that is located in the piston 18 and the spindle 42 is in communication with a nut 48 via a plurality of rolling elements 46 that are located within threads 44 of the spindle 42 and nut 48. As the spindle 42 is rotated with support of a bearing 50 the nut 48 axially moves the piston 18 so that a braking force is created.

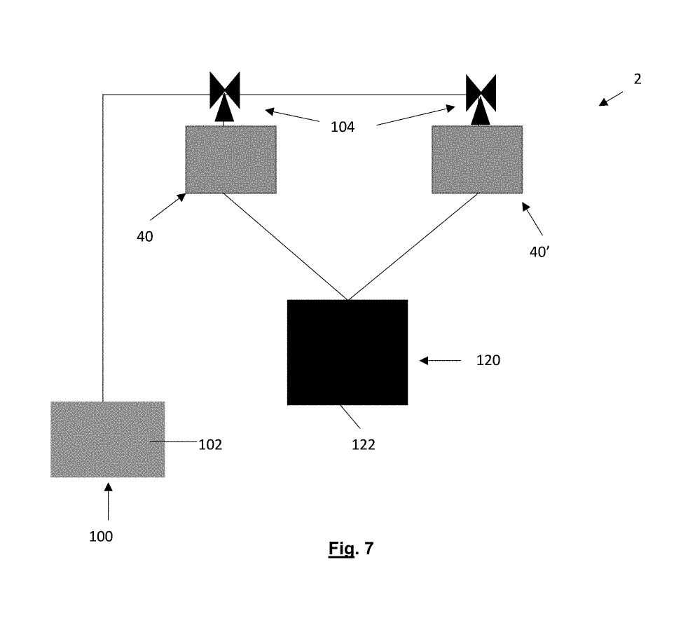

FIG. 7 illustrates a schematic view of a brake system 2. The brake system 2 includes two motor gear units (40, 40′). Each of the motor gear units (40, 40′) are connected to a hydraulic system 100 and a control system 120. The hydraulic system 100 includes a hydraulic unit 102 that provides hydraulic fluid to one or both of the motor gear units (40, 40′). The amount of hydraulic fluid may be controlled by a valve 104 located between the hydraulic unit 102 and each of the motor gear units (40, 40′). The control system 120 includes a control unit 122 that provides electric signals to each of the motor gear units (40, 40′) so that each motor gear unit (40, 40′) can be actuated separately or together.

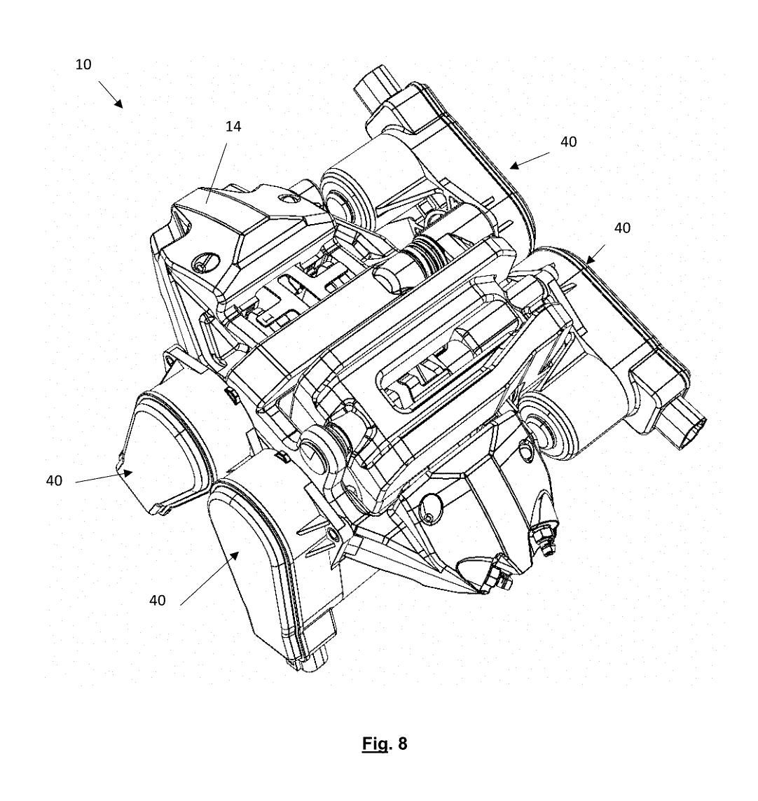

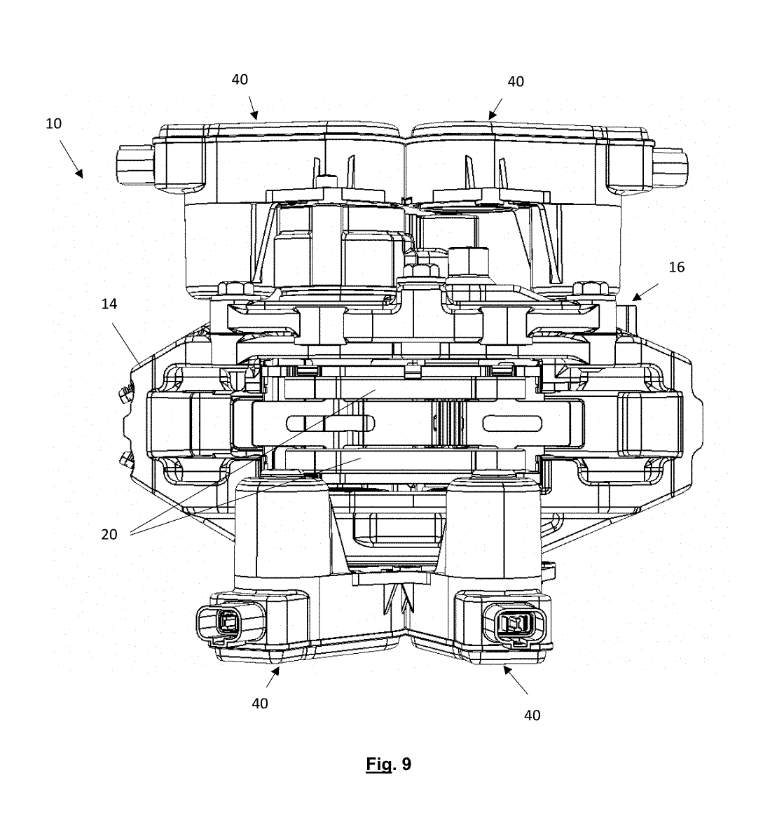

FIG. 8 is a to perspective view of a brake assembly 10. The brake assembly includes a caliper 14 with four motor gear units 40 connected to the piston bores (not shown) in the caliper 14.

FIG. 9 is a bottom view of a brake assembly 10. The brake assembly includes a caliper 14 including four piston bores 16. A pair of brake pads 20 are located within the caliper 14. Each of the piston bores 16 are connected to a motor gear unit 40 and each motor gear unit 40 moves a piston (not shown) located within the caliper 14.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

We claim:

1) A brake system comprising:
a. a brake assembly including;
i. a caliper including:
1. two or more piston bores,
2. a piston located in each of the two or more piston bores, and
3. a rotary to linear actuator in each of the two or more piston bores, the rotary to linear actuators being rotationally movable to linearly move each of the pistons within the two or more piston bores to create a braking force;
ii. a motor gear unit in communication with each of the two or more piston bores and in communication with each of the rotary to linear actuators extending into each of the two or more piston bores;
wherein each of the rotary to linear actuators include threads that receive a plurality of rolling elements and when each of the rotary to linear actuators are rotated the two or more pistons located in each of the two or more piston bores are moved by the respective rotary to linear actuator to create a braking force or releasing a braking force.

2) The brake system of claim 1, wherein each of the two or more piston bores include a nut with threads and each of the nuts are in communication with a spindle of one of the rotary to linear actuator via the plurality of rolling elements and the nuts are axially moved by rotation of the spindles so that the braking force is created or the braking force is released by axial movement of the nut.

3) The brake system of claim 1, wherein each of the rotary to linear actuators include a spindle that is in direct contact with one of the pistons located in each of the two or more piston bores and the pistons include threads that receive the plurality of rolling elements to that rotation of the spindle causes axial movement of the piston to create the braking force or release the braking force.

4) The brake system of claim 1, wherein the caliper is directly connected to a knuckle of a vehicle.

5) The brake system of claim 4, wherein the brake system includes a rotor and the caliper extends around the rotor so that a portion of the caliper is located on a first side of the rotor and a portion of the caliper is located on a second side of the rotor.

6) The brake system of claim 4, wherein the two or more piston bores are opposing piston bores and during creation of the braking force the pistons move within the two or more piston bores in a direction towards an opposing piston bore.

7) The brake system of claim 1, wherein the brake assembly includes a support bracket that connects the caliper to a knuckle of a vehicle and the caliper moves relative to the support bracket during creating of the braking force or release of the braking force.

8) The brake system of claim 1, wherein the rolling elements are ball bearings, cylinders, or both.

9) The brake system of claim 1, wherein the two or more piston bores are located on a same side of the caliper.

10) The brake system of claim 1, wherein the motor gear unit includes a motor and one or more gear assemblies that provide torque from the motor to a spindle of the rotary to linear actuator so that the spindle is rotated and axially moves the piston.

11) The brake system of claim 1, wherein the motor gear unit includes a motor brake that prevents back drive of the spindle when the braking force is created and a motor in the motor gear unit is turned off.

12) The brake system of claim 1, wherein the two or more piston bores are three piston bores and each of the three piston bores include one of the motor gear units, and during a standard parking brake application only the motor gear unit connected to a middle piston bore of the three piston bores is activated.

13) The brake system of claim 1, wherein a service brake apply is created by an electric motor, hydraulic fluid, or both.

14) The brake system of claim 1, wherein the motor gear units in communication with each of the two or more piston bores are in communication with a control system and the control system applies each of the motor gear units together or alternates between each of the motor gear units.

15) The brake system of claim 1, wherein the rotary to linear actuator is a ball ramp.

16) A method comprising:
a. supplying a signal to both a first motor in a first motor gear unit and a second motor in a second motor gear unit simultaneously;
b. alternating the signal between the first motor in the first motor gear unit and the second motor in the second motor gear unit once contact between a brake pad and a rotor is detected;
c. applying the first motor in the first motor gear unit or the second motor in the second motor gear unit and alternating between the first motor in the first motor gear unit and the second motor in the second motor gear unit until a predetermined braking force is generated; and
d. turning off the first motor and the second motor so that a motor brake is applied to the first motor and a motor brake is applied to the second motor.

17) The method of claim 16, wherein the first motor, the second motor is reclamped after a predetermined condition is met.

18) The method of claim 17, wherein the predetermined condition is an amount of time.

19) The method of claim 16, wherein the motor brake is released before the first motor, the second motor, or both are turned back on.

20) The method of claim 16, wherein the first motor gear unit and the second motor gear unit are in communication with a rotary to linear actuator and the rotary to linear actuators each axially move a respective piston when the first motor and second motor are activated.
